(19) United States
(12) Patent Application Publication
(10) Pub. No.: US 2017/0286168 A1
(43) Pub. Date: Oct. 5, 2017

(54) BALANCING THREAD GROUPS

(71) Applicant: HEWLETT PACKARD ENTERPRISE DEVELOPMENT LP, Houston, TX (US)

(72) Inventors: Ben Simpson, Andover, MA (US); Jake Hoggans, Bristol (GB)

(21) Appl. No.: 15/507,693

(22) PCT Filed: Nov. 11, 2014
(86) PCT No.: PCT/US2014/064957

§ 371 Date: Feb. 28, 2017

(51) Int. Cl. G06F 9/50; G06F 9/54

(52) U.S. Cl. CPC G06F 9/505; G06F 9/542

(57) ABSTRACT

A method for balancing thread groups across a plurality of processor cores identifies the processor cores executing active thread groups. A processor core with a lowest number of active thread groups is identified. A new thread group is assigned to the processor core with the lowest number of active thread groups when the new thread group becomes active.

### BACKGROUND

Inter-process communication (IPC) is the method of exchanging data between processes that are running on computers connected by a network. When the processes are running on different processor cores, the IPC can create latency. Latency is a delay in processing time. This latency, when coupled with frequent communication between processes, contributes to the degraded performance of the processing workloads.

### BRIEF DESCRIPTION OF THE DRAWINGS

Certain exemplary embodiments are described in the following detailed description and in reference to the drawings, in which:

FIG. 1 is a block diagram of an example thread group balancing system.

FIG. 2 is a process flow diagram of an example thread group balancing method.

FIG. 3 is a block diagram f an example thread group balancing method.

FIG. 4 is a block diagram of an example computer-readable medium that stores code configured to operate a thread group balancing system.

### DETAILED DESCRIPTION

Computer processes may consist of multiple related threads. These threads are organized into thread groups. On a multi-processor computing device, each thread group is assigned to a processing core for execution. To improve throughput of the device, and decrease potential latency, it is useful to balance the load of thread groups across the processor cores.

There are several possible approaches for balancing the load of thread groups across multiple processor cores. In a naïve approach, thread groups may be numbered sequentially, and split evenly across the number of cores available using the following equation: c=t mod n Where t is the thread group ID, n is the number of cores available in the system, and c is the core to be assigned to. Thee advantage of this approach is that it is very simple to implement. However, this approach does not take in to account the load of the individual thread groups. As such, the naïve approach could result in heavily loaded cores, thereby negatively impacting the performance of the thread groups.

In a balanced approach, the thread group is assigned to the core with the lowest load at the moment when the thread group becomes active. The thread group becomes active when entering the IPC-intensive operation mode. The core with the lowest load can be identified by monitoring the idle cycles of each core. Accordingly, thread groups are assigned to the core with highest number of idle cycles. The inverse of this approach is also possible. In other words, processor cores that are heavily loaded are not considered when assigning the thread group. A heavily loaded core may be identified by exceeding a predetermined threshold. The advantage of this approach is that it attempts to maintain system performance by not overloading particular cores. However, as the workload of thread groups vary over time, this approach may still result in an overloaded processor core.

Some examples may distribute groups of threads in a multiple-core system environment to reduce latency in interprocess communication (IPC). Additionally, the throughput performance of workloads can be improved.

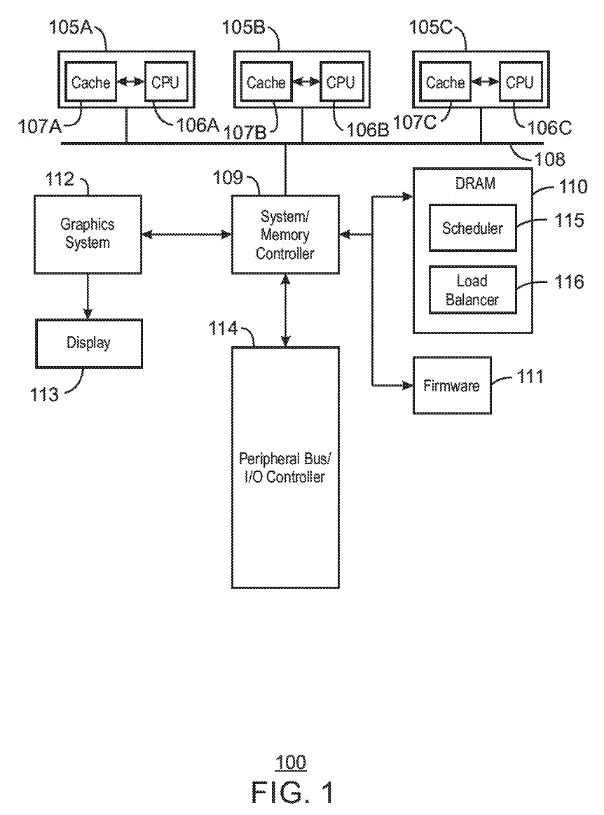

FIG. 1 is a block diagram of an example thread group balancing system. The functional blocks and devices shown in FIG. 1 may include hardware elements including circuitry, software elements including computer code stored on a tangible, non-transitory, machine-readable medium, or a combination of both hardware and software elements. Additionally, the functional blocks and devices of the system 100 are but one example of functional blocks and devices that may be implemented in examples. The system 100 can include any number of computing devices, such as smart phones, computers, servers, laptop computers, wearable devices, or other computing devices.

The system 100 includes a number of central processing units (CPUs) 105a, 105b, 105c, each of which include a CPU core 106a, 106b, 106c connected to a cache memory 107a, 107b, 107c. The example system 100 includes one processor core 106a, 106b, 106c per CPU 105a, 105b, 105c. However, in some examples, each CPU may include multiple processor cores.

The CPUs 105a, 105b, 105c are further connected via a local bus 108 to a system and memory controller 109 that deals with access to a physical memory 110, for example in the form of dynamic random access memory (DRAM), and controls access to system firmware 111 stored, for example, in non-volatile random access memory (RAM), as well as controlling the graphics system 112, which is connected to a display 113. The system and memory controller 109 is also connected to a peripheral bus and input/output ((I/O) controller 114 that provides support for other computer subsystems. These subsystems include peripheral, I/O, and other devices, such as a magnetic disk drive, optical disk drive, keyboard, and mouse.

The physical memory 110 includes a scheduler 115, and a load balancer 116. The scheduler 115 is responsible for scheduling thread groups for execution. Thee load balancer 116 is responsible for assigning thread groups to a processor core 106a, 106b, 106c. When a thread group is assigned to a core, the thread group is executed by the scheduler 115.

In some scenarios, there can be several groups of threads (running across multiple processor cores 106a, 106b, 106c). The naïve approach to load balancing could interfere with the scheduler's performance because some cores 106a, 106b, 106c could become heavily overloaded. Accordingly, the scheduler 115 may end up performing extra work by trying to balance other tasks in the system 100 across the other cores. This may result in poor performance for the other tasks in the system. Additionally, affecting the scheduler 115 in this way could lead to an unstable system 100, and produce unexpected results, negatively impacting the rest of the system 100.

Further, these threads may use IPC. In such scenarios, the associated performance loss due to IPC can be significant. The delay in IPC may be caused by the overhead inherent in swapping data between different caches 107a, 107b, 107c in the processor architecture. However, by running dependent threads on the same processor core, this inherent latency can be reduced. In some examples, the load balancer 116 assigns dependent threads as a group to the same processor core 106a, 106b, 106c. Further, thread groups are balanced across all available processor cores 106a, 106b, 106c for efficient system performance.

Some examples use an equal distribution method for assigning thread groups to processor cores 106a, 106b, 106c, to reduce IPC latency issues while maintaining system stability, and system performance by not interfering with the operating system scheduler 115. Advantageously, greater system performance may be achieved by reducing CPU cache overhead. In this way, the performance of computer processes including a number of threads communicating via IPC may be improved. Additionally, some examples may reduce IPC latency on Hyper-Threaded cores without providing exceptions. Further, two logical cores running on one physical core have an inherent IPC latency. Accordingly, some examples may treat logical cores the same as physical processor cores.

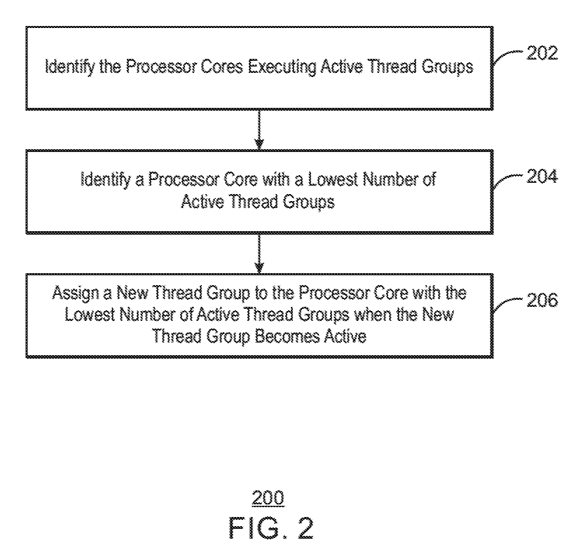

FIG. 2 is a process flow diagram of an equal distribution method 200 for balancing thread groups. It is noted that the process flow diagram is not intended to indicate a sequence, merely the techniques employed by examples of the present subject matter. The method 200 is performed by the load balancer 116 when a new thread group becomes active. The method 200 begins at block 202, where the load balancer 116 identifies the processor cores 106a, 106b, 106c executing active thread groups. At block 204, the load balancer 116 identifies the processor core with a lowest number of active thread groups. At block 206, the load balancer 116 assigns a new thread group to the processor core with the lowest number of active thread groups. In some scenarios, more than 1 processor core may have the lowest number of active thread groups. For example, 2 cores may have only 1 active thread group assigned. In such a scenario, the newly active thread group may be assigned in ascending or descending order. Alternatively, any other assignment technique that assigns a newly active thread group to one of the processor cores with the lowest number of active thread groups may be used.

When the first thread groups are assigned, i.e., the number of active thread groups on all processor cores is 0, thread groups may be balanced across the cores in ascending numerical order. For example, in an environment in which there are only 2 processor cores available, cores 1 and 2. In such an environment, the first active thread group may be assigned to core 1, and the second thread group may be assigned to core 2. When a third thread group becomes active, the other thread groups that are still active are identified because it is not safe to assume that the other thread groups are still running. If the 2nd thread group, assigned to core 2, has finished execution, core 2 has 0 active thread groups. Accordingly, the newly active thread group is assigned to core 2. Alternatively, if the first thread group has finished execution, the newly active thread group is assigned to core 1.

In some scenarios, more than 1 processor core may have the lowest number of active thread groups. For example, two (or more) cores may have only 1 active thread group assigned, while the remaining cores have 2 thread groups assigned. In such a scenario, the newly active thread group may be assigned in ascending or descending order to the cores with 1 active thread group. Alternatively, any other assignment technique that assigns a thread group to one of the processor cores with the lowest number of active thread groups may be used.

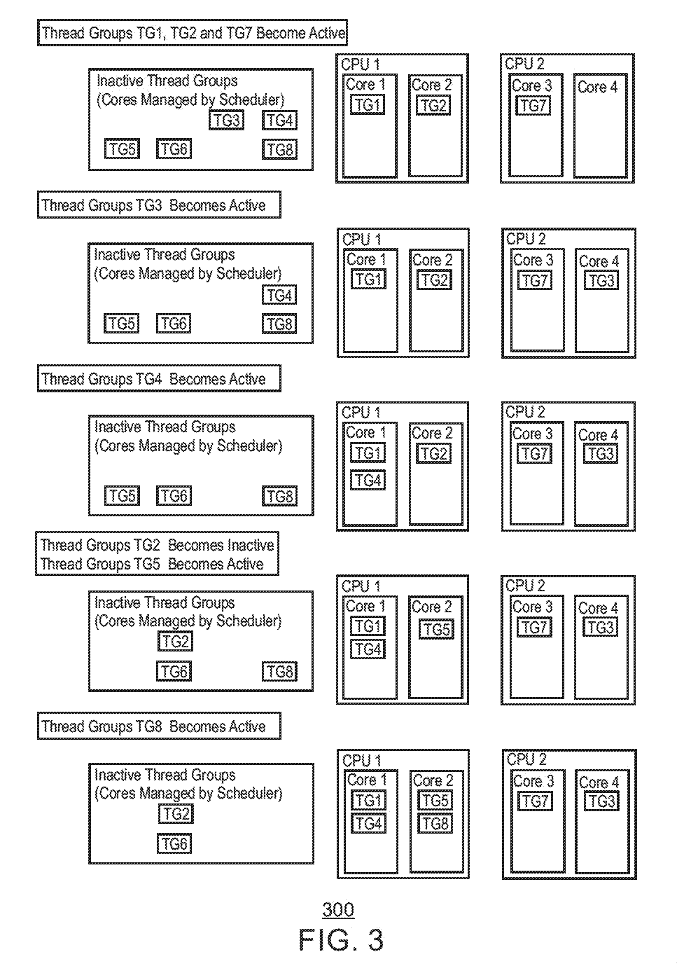

FIG. 3 is a block diagram representing an example equal distribution method for balancing thread groups. In this example, thread groups TG1-TG8 are balanced across CPUs 1 and 2. The CPUs each include 2 processor cores: cores 1 and 2, and cores 3 and 4, respectively, for CPUs 1 and 2. At block 302, thread groups TG1, TG2, and TG7 become active. The load balancer 116 identifies no processor cores with active thread groups. Accordingly, the newly active thread groups may be assigned to processor cores in ascending order. As shown, thread groups TG1, TG2, and TG7 are assigned to processor cores 1, 2, and 3, respectively. It is noted that other assignment techniques are possible, such as descending order.

At block 304, TG3 becomes active. Processor cores 1-3 are identified as each having 1 active thread group. However, processor core 4 has the lowest number of active thread groups, 0. Thus, TG3 is assigned to processor core 4. At block 306, TG4 becomes active. All processor cores have 1 active thread group. According to the ascending order, the newly active TG4 is thus assigned to processor core 1.

At block 308, TG2 becomes inactive, and TG5 becomes active. The load balancer 116 identifies processor cores 1, 3, and 4 as having active thread groups. However, processor core 2 has no active thread groups because TG2 is inactive. Thus, TG5 is assigned to processor core 2.

At block 310, TG8 becomes active. The load balancer 116 identifies all processor cores as having active thread groups. Processor cores 2, 3, and 4 have the lowest number of active thread groups. Thus, TG8 may be assigned to either of these cores. Using an ascending order technique, TG8 may be assigned to processor core 2.

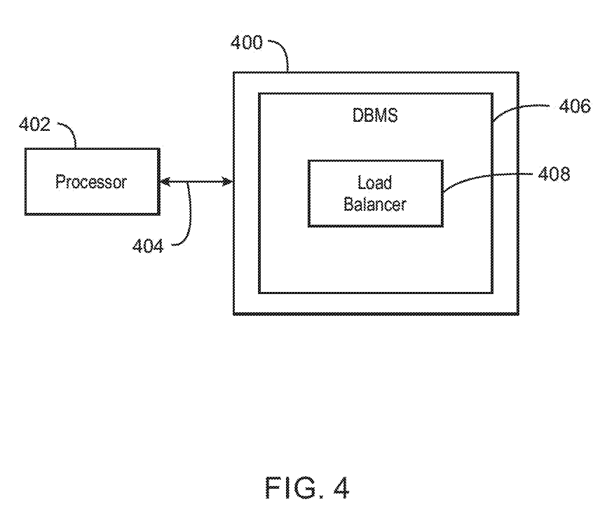

FIG. 4 is a block diagram of an example of a tangible, non-transitory, computer-readable medium that stores code configured to operate a thread group balancing system. The computer-readable medium is referred to by the reference number 400. The computer-readable medium 400 can include RAM, a hard disk drive, an array of hard disk drives, an optical drive, an array of optical drives, a non-volatile memory, a flash drive, a digital versatile disk (DVD), or a compact disk (CD), among others. The computer-readable medium 400 can be accessed by a controller 402 over a computer bus 404. Further, the computer-readable medium 400 may include a load balancer 406 to perform the methods and provide the systems described herein. The various software components discussed herein may be stored on the computer-readable medium 400.

Advantageously, examples of the present techniques provide a thread group balancing system that has the ability and responsibility to assign thread groups to processor cores in a manner that reduces the impact of an unbalanced assignment of workloads. Further, by assigning a group of threads to the same processing core, the impact of interprocess communication on overall system performance.

While the present techniques may be susceptible to various modifications and alternative forms, the exemplary examples discussed above have been shown only by way of example. It is to be understood that the technique is not intended to be limited to the particular examples disclosed herein.

What is claimed is:

1. A method for balancing thread groups across a plurality of processor cores, comprising:
identifying the processor cores executing active thread groups;
identifying a processor core with a lowest number of active thread groups; and
assigning a new thread group to the processor core with the lowest number of active thread groups when the new thread group becomes active.

2. The method of claim 1, comprising assigning the new thread group in ascending order when more than one processor core has the lowest number of active thread groups.

3. The method of claim 1, comprising assigning the new thread group in descending order when more than one processor core has the lowest number of active thread groups.

4. The method of claim 1, wherein the active thread groups perform interprocess communication.

5. The method of claim 1, comprising determining that the new thread group has become active when the new group begins interprocess communication.

6. The method of claim 4, comprising determining that the new thread group has become active when the new group begins interprocess communication.

7. The method of claim 1, comprising assigning the new thread group in ascending order when none of the processor cores have active thread groups assigned.

8. A computing system, comprising:
a processor; and
a memory comprising code executed to cause the processor to:
identify the processor cores executing active thread groups;
identify a processor core with a lowest number of active thread groups; and
assign a new thread group to the processor core with the lowest number of active thread groups when the new thread group becomes active.

9. The computer system of claim 8, the code executed to cause the processor to assign the new thread group in ascending order when more than one processor core has the lowest number of active thread groups.

10. The computer system of claim 8, the code executed to cause the processor to assign the new thread group in descending order when more than one processor core has the lowest number of active thread groups.

11. The computer system of claim 8, wherein the active thread groups perform interprocess communication.

12. The computer system of claim 8, the code executed to cause the processor to determine that the new thread group has become active when the new group begins interprocess communication.

13. The computer system of claim 11, the code executed to cause the processor to determine that the new thread group has become active when the new group begins interprocess communication.

14. The computer system of claim 8, the code executed to cause the processor to assign the new thread group in ascending order when none of the processor cores have active thread groups assigned.

15. A tangible, non-transitory, computer-readable medium comprising instructions directing a processor to:
identify the processor cores executing active thread groups;
identify a processor core with a lowest number of active thread groups;
assign a new thread group to the processor core with the lowest number of active thread groups when the new thread group becomes active; and
assign the new thread group in descending order when more than one processor core has the lowest number of active thread groups.
